(19) United States
(12) Patent Application Publication
(10) Pub. No.: US 2026/0046798 A1
(43) Pub. Date: Feb. 12, 2026

(54) METHOD AND APPARATUS RELATED TO TIMING SYNCHRONISATION STATUS REPORTS

(71) Applicant: Nokia Technologies Oy, Espoo (FI)

(72) Inventors: Pilar ANDRÉS MALDONADO, Aalborg (DK); Devaki CHANDRAMOULI, Dallas, TX (US); Troels Emil KOLDING, Aalborg (DK)

(21) Appl. No.: 19/101,676

(22) PCT Filed: Aug. 7, 2023
(86) PCT No.: PCT/IB2023/057968

§ 371 Date: Feb. 6, 2025

(30) Foreign Application Priority Data
Aug. 9, 2022 (GB) 2211611.5

(51) Int. Cl. H04W 56/00; H04W 68/00

(52) U.S. Cl. CPC H04W 56/0015; H04W 68/005

(57) ABSTRACT

A method comprising receiving a message identifying at least one user equipment for which action is to be taken to increase certainty of reading by the user equipment of a timing synchronisation status report; and based at least partly on information about the user equipment, determining an action for increasing certainty of reading by the user equipment of the timing synchronisation status report.

### RELATED APPLICATIONS

This application claims the benefit of priority of United Kingdom Patent Application No. 2211611.5 filed Aug. 9, 2022, the contents of which are hereby incorporated by reference as if reproduced in their entirety.

### TECHNICAL FIELD

Example embodiments relate to apparatus, a method, and a computer program, and in particular, but not exclusively to apparatus, methods and computer programs related to timing synchronisation status reports.

### BACKGROUND

When a radio access network node detects that there is a reportable event relating to the time source that the radio access network node is using as a time reference, the radio access network node may broadcast a timing synchronisation status report.

### SUMMARY

According to an aspect, there is provided a method, comprising receiving a message identifying at least one user equipment for which action is to be taken to increase certainty of reading by the user equipment of a timing synchronisation status report; and based at least partly on information about the user equipment, determining an action for increasing certainty of reading by the user equipment of the timing synchronisation status report.

The message may include an indication of a level of urgency for increasing certainty of reading by the user equipment of the timing synchronisation status report; and the determining an action may be based partly on the indication of the level of urgency.

The timing synchronisation status report may be broadcast as part of system information, the information about the user equipment may comprise information about periodicity at which the user equipment reads broadcast system information; and the method may comprise determining at least one parameter for the broadcast of the timing synchronisation status report as part of system information, based on the information about periodicity at the user equipment of reading broadcast system information.

The at least one parameter may comprise a duration for which the timing synchronisation status report is included in system information.

The method may comprise determining whether to page the user equipment to report reading of the timing synchronisation status report, wherein the determining is at least partly based on one or more of: information derived from user equipment messages, or information about when to expect user equipment messages.

Determining whether to page the user equipment to report reading of the timing synchronisation status report may be at least partly based on one or more of: information derived from one or more messages from the user equipment including a field for indicating reading of the timing synchronisation status report, or information about when the user equipment is next expected to send a message including a field for indicating reading of the timing synchronisation status report.

The information about the user equipment may include the radio resource control status of the user equipment, and the method may comprise in response to determining that the user equipment is in radio resource control idle mode, paging the user equipment about broadcast of the timing synchronisation status report.

According to another aspect, there is provided a method comprising receiving a message identifying at least one user equipment for which action is to be taken to increase certainty of reading by the user equipment of a timing synchronisation status report, paging the user equipment about broadcast of a timing synchronisation status report, and thereafter broadcasting the timing synchronisation report.

According to still another aspect, there is provided a method comprising sending, from a user equipment, information about periodicity of reading at the user equipment of a system information block.

According to still another aspect, there is provided a method comprising sending, from a user equipment, an indication that action is to be taken to increase certainty of reading of a timing synchronisation status report by the user equipment.

According to still another aspect, there is provided a method, comprising receiving a paging message indicating broadcast of system information including a timing synchronisation status report, and reading the system information indicated by the paging message.

According to still another aspect, there is provided a method, comprising sending a request identifying at least one user equipment for which action is to be taken to increase certainty of reading by the user equipment of a timing synchronisation status report.

The request may include an indication of a level of urgency for increasing certainty of reading by the user equipment of the timing synchronisation status report.

According to still another aspect, there is provided an apparatus comprising means for receiving a message identifying at least one user equipment for which action is to be taken to increase certainty of reading by the user equipment of a timing synchronisation status report; and means for, based at least partly on information about the user equipment, determining an action for increasing certainty of reading by the user equipment of the timing synchronisation status report.

The message may include an indication of a level of urgency for increasing certainty of reading by the user equipment of the timing synchronisation status report; and the determining an action may be based partly on the indication of the level of urgency.

The timing synchronisation status report may be broadcast as part of system information, the information about the user equipment may comprise information about a periodicity at which the user equipment reads broadcast system information; and the apparatus may comprise means for determining at least one parameter for the broadcast of the timing synchronisation status report as part of system information, based on the information about periodicity at the user equipment of reading broadcast system information.

The at least one parameter may comprise a duration for which the timing synchronisation status report is included in system information.

The apparatus may comprise means for determining whether to page the user equipment to report reading of the timing synchronisation status report, at least partly based on one or more of: information derived from user equipment messages, or information about when to expect user equipment messages.

Determining whether to page the user equipment to report reading of the timing synchronisation status report may be at least partly based on one or more of: information derived from one or more messages from the user equipment including a field for indicating reading of the timing synchronisation status report, or information about when the user equipment is next expected to send a message including a field for indicating reading of the timing synchronisation status report.

The information about the user equipment may include the radio resource control status of the user equipment, and the apparatus may comprise means for: in response to determining that the user equipment is in radio resource control idle mode, paging the user equipment about broadcast of the timing synchronisation status report.

According to still another aspect, there is provided an apparatus comprising: means for receiving a message identifying at least one user equipment for which action is to be taken to increase certainty of reading by the user equipment of a timing synchronisation status report; means for paging the user equipment about broadcast of a timing synchronisation status report; and means for thereafter broadcasting the timing synchronisation report.

According to still another aspect, there is provided a user equipment comprising: means for sending information about periodicity of reading at the user equipment of a system information block.

According to still another aspect, there is provided a user equipment comprising: means for sending an indication that action is to be taken to increase certainty of reading by the user equipment of a timing synchronisation status report.

According to still another aspect, there is provided a user equipment, comprising: means for receiving a paging message indicating broadcast of system information including a timing synchronisation status report, and means for reading the system information indicated by the paging message.

According to still another aspect, there is provided an apparatus comprising: means for sending a request identifying at least one user equipment for which action is to be taken to increase certainty of reading by the user equipment of a timing synchronisation status report.

The request may include an indication of a level of urgency for increasing certainty of reading by the user equipment of the timing synchronisation status report.

According to still another aspect, there is provided an apparatus comprising: at least one processor; and at least one memory including computer program code, the at least one memory and computer program code configured to, with the at least one processor, cause the apparatus to perform: receiving a message identifying at least one user equipment for which action is to be taken to increase certainty of reading by the user equipment of a timing synchronisation status report; and based at least partly on information about the user equipment, determining an action for increasing certainty of reading by the user equipment of the timing synchronisation status report.

The message may include an indication of a level of urgency for increasing certainty of reading by the user equipment of the timing synchronisation status report; and the determining an action may be based partly on the indication of the level of urgency.

The timing synchronisation status report may be broadcast as part of system information, the information about the user equipment may comprise information about periodicity at which the user equipment reads broadcast system information; and the at least one memory and computer program code may be configured to, with the at least one processor, cause the apparatus to determine at least one parameter for the broadcast of the timing synchronisation status report as part of system information, based on the information about periodicity at the user equipment of reading broadcast system information.

The at least one parameter may comprise a duration for which the timing synchronisation status report is included in system information.

The at least one memory and computer program code may be configured to, with the at least one processor, cause the apparatus to determine whether to page the user equipment to report reading of the timing synchronisation status report, at least partly based on one or more of: information derived from user equipment messages, or information about when to expect user equipment messages.

The at least one memory and computer program code may be configured to, with the at least one processor, cause the apparatus to determine whether to page the user equipment to report reading of the timing synchronisation status report at least partly based on one or more of: information derived from one or more messages from the user equipment including a field for indicating reading of the timing synchronisation status report, or information about when the user equipment is next expected to send a message including a field for indicating reading of the timing synchronisation status report.

The information about the user equipment may include the radio resource control status of the user equipment, and the at least one memory and computer program code may be configured to, with the at least one processor, cause the apparatus to: in response to determining that the user equipment is in radio resource control idle mode, page the user equipment about broadcast of the timing synchronisation status report.

According to still another aspect, there is provided an apparatus comprising: at least one processor; and at least one memory including computer program code, the at least one memory and computer program code configured to, with the at least one processor, cause the apparatus to perform: receiving a message identifying at least one user equipment for which action is to be taken to increase certainty of reading by the user equipment of a timing synchronisation status report; paging the user equipment about broadcast of a timing synchronisation status report; and thereafter broadcasting the timing synchronisation report.

According to still another aspect, there is provided a user equipment comprising: at least one processor; and at least one memory including computer program code, the at least one memory and computer program code configured to, with the at least one processor, cause the user equipment to perform: sending information about periodicity of reading at the user equipment of a system information block.

According to still another aspect, there is provided a user equipment comprising: at least one processor; and at least one memory including computer program code, the at least one memory and computer program code configured to, with the at least one processor, cause the user equipment to perform: sending an indication that action is to be taken to increase certainty of reading by the user equipment of a timing synchronisation status report.

According to still another aspect, there is provided a user equipment comprising: at least one processor; and at least one memory including computer program code, the at least one memory and computer program code configured to, with the at least one processor, cause the user equipment to perform: receiving a paging message indicating broadcast of system information including a timing synchronisation status report, and reading the system information indicated by the paging message.

According to still another aspect, there is provided an apparatus comprising: at least one processor; and at least one memory including computer program code, the at least one memory and computer program code configured to, with the at least one processor, cause the apparatus to perform: sending a request identifying at least one user equipment for which action is to be taken to increase certainty of reading by the user equipment of a timing synchronisation status report.

The request may include an indication of a level of urgency for increasing certainty of reading by the user equipment of the timing synchronisation status report.

According to still another aspect, there is provided an apparatus comprising: receiving circuitry for receiving a message identifying at least one user equipment for which action is to be taken to increase certainty of reading by the user equipment of a timing synchronisation status report; and determining circuitry for, based at least partly on information about the user equipment, determining an action for increasing certainty of reading by the user equipment of the timing synchronisation status report.

According to still another aspect, there is provided an apparatus comprising: receiving circuitry for receiving a message identifying at least one user equipment for which action is to be taken to increase certainty of reading by the user equipment of a timing synchronisation status report; paging circuitry for paging the user equipment about broadcast of a timing synchronisation status report; and broadcasting circuitry for thereafter broadcasting the timing synchronisation report.

According to still another aspect, there is provided a user equipment comprising: sending circuitry for sending information about periodicity of reading at the user equipment of a system information block.

According to still another aspect, there is provided a user equipment comprising: sending circuitry for sending an indication that action is to be taken to increase certainty of reading by the user equipment of a timing synchronisation status report.

According to still another aspect, there is provided a user equipment, comprising: receiving circuitry for receiving a paging message indicating broadcast of system information including a timing synchronisation status report, and reading circuitry for reading the system information indicated by the paging message.

According to still another aspect, there is provided an apparatus comprising: sending circuitry for sending a request identifying at least one user equipment for which action is to be taken to increase certainty of reading by the user equipment of a timing synchronisation status report.

According to still another aspect, there is provided a computer readable medium comprising program instructions stored thereon for performing: receiving a message identifying at least one user equipment for which action is to be taken to increase certainty of reading by the user equipment of a timing synchronisation status report; and based at least partly on information about the user equipment, determining an action for increasing certainty of reading by the user equipment of the timing synchronisation status report.

According to still another aspect, there is provided a computer readable medium comprising program instructions stored thereon for performing: receiving a message identifying at least one user equipment for which action is to be taken to increase certainty of reading by the user equipment of a timing synchronisation status report; paging the user equipment about broadcast of a timing synchronisation status report; and thereafter broadcasting the timing synchronisation report.

According to still another aspect, there is provided a computer readable medium comprising program instructions stored thereon for performing: sending, from a user equipment, information about periodicity of reading at the user equipment of a system information block.

According to still another aspect, there is provided a computer readable medium comprising program instructions stored thereon for performing: sending, from a user equipment, an indication that action is to be taken to increase certainty of reading by the user equipment of a timing synchronisation status report.

According to still another aspect, there is provided a computer readable medium comprising program instructions stored thereon for performing: receiving a paging message indicating broadcast of system information including a timing synchronisation status report and reading the system information indicated by the paging message.

According to still another aspect, there is provided a computer readable medium comprising program instructions stored thereon for performing: sending a request identifying at least one user equipment for which action is to be taken to increase certainty of reading by the user equipment of a timing synchronisation status report.

According to still another aspect, there is provided a non-transitory computer readable medium comprising program instructions stored thereon for performing receiving a message identifying at least one user equipment for which action is to be taken to increase certainty of reading by the user equipment of a timing synchronisation status report; and based at least partly on information about the user equipment, determining an action for increasing certainty of reading by the user equipment of the timing synchronisation status report.

According to still another aspect, there is provided a non-transitory computer readable medium comprising program instructions stored thereon for performing receiving a message identifying at least one user equipment for which action is to be taken to increase certainty of reading by the user equipment of a timing synchronisation status report; paging the user equipment about broadcast of a timing synchronisation status report; and thereafter broadcasting the timing synchronisation report.

According to still another aspect, there is provided a non-transitory computer readable medium comprising program instructions stored thereon for performing: sending, from a user equipment, information about periodicity of reading at the user equipment of a system information block.

According to still another aspect, there is provided a non-transitory computer readable medium comprising program instructions stored thereon for performing: sending, from a user equipment, an indication that action is to be taken to increase certainty of reading by the user equipment of a timing synchronisation status report.

According to still another aspect, there is provided a non-transitory computer readable medium comprising program instructions stored thereon for performing: receiving a paging message indicating broadcast of system information including a timing synchronisation status report and reading the system information indicated by the paging message.

A non-transitory computer readable medium comprising program instructions stored thereon for performing sending a request identifying at least one user equipment for which action is to be taken to increase certainty of reading by the user equipment of a timing synchronisation status report.

According to still another aspect, there is provided a computer program comprising computer executable code which when run on at least one processor is configured to cause an apparatus at least to: receive a message identifying at least one user equipment for which action is to be taken to increase certainty of reading by the user equipment of a timing synchronisation status report; and based at least partly on information about the user equipment, determine an action for increasing certainty of reading by the user equipment of the timing synchronisation status report.

According to still another aspect, there is provided a computer program comprising computer executable code which when run on at least one processor is configured to cause an apparatus at least to: receive a message identifying at least one user equipment for which action is to be taken to increase certainty of reading by the user equipment of a timing synchronisation status report; page the user equipment about broadcast of a timing synchronisation status report; and thereafter broadcast the timing synchronisation report.

According to still another aspect, there is provided a computer program comprising computer executable code which when run on at least one processor is configured to cause a user equipment at least to: send information about periodicity of reading at the user equipment of a system information block.

According to still another aspect, there is provided a computer program comprising computer executable code which when run on at least one processor is configured to cause a user equipment at least to: send an indication that action is to be taken to increase certainty of reading by the user equipment of a timing synchronisation status report.

According to still another aspect, there is provided a computer program comprising computer executable code which when run on at least one processor is configured to cause a user equipment at least to: receive a paging message indicating broadcast of system information including a timing synchronisation status report and read the system information indicated by the paging message.

According to still another aspect, there is provided a computer program comprising computer executable code which when run on at least one processor is configured to cause an apparatus at least to: send a request identifying at least one user equipment for which action is to be taken to increase certainty of reading by the user equipment of a timing synchronisation status report.

In the above, many different aspects have been described. It should be appreciated that further aspects may be provided by the combination of any two or more of the aspects described above.

Various other aspects are also described in the following detailed description and in the attached claims.

### BRIEF DESCRIPTION OF THE FIGURES

Some example embodiments will now be described in further detail, by way of example only, with reference to the following examples and accompanying drawings, in which:

FIG. 1 shows an example mobile communication system to which some example embodiments may be applied;

FIG. 2 shows a representation of an example of operations of some elements of FIG. 1 according to some example embodiments;

FIG. 3 shows a representation of an example of operations of some elements of FIG. 1 according to some example embodiments;

FIG. 4 shows a representation of an example of operations of some elements of FIG. 1 according to some example embodiments;

FIG. 5 shows a representation of an example of operations of some elements of FIG. 1 according to some example embodiments;

FIG. 6 shows a representation of an example of operations of some elements of FIG. 1 according to some example embodiments;

FIG. 7 shows a representation of an example of apparatus for implementing user equipment functionality or access node functionality according to some example embodiments;

FIG. 8 shows a representation of an example of apparatus for implementing network functions according to some example embodiments; and

FIG. 9 shows a representation of an example of non-volatile memory media.

### DETAILED DESCRIPTION

By way of example, the following description focusses on the example of a mobile communications system operating according to 3GPP 5G technology, but the underlying technique may also be applicable to systems operating according to other technologies, such as more evolved 3GPP technologies.

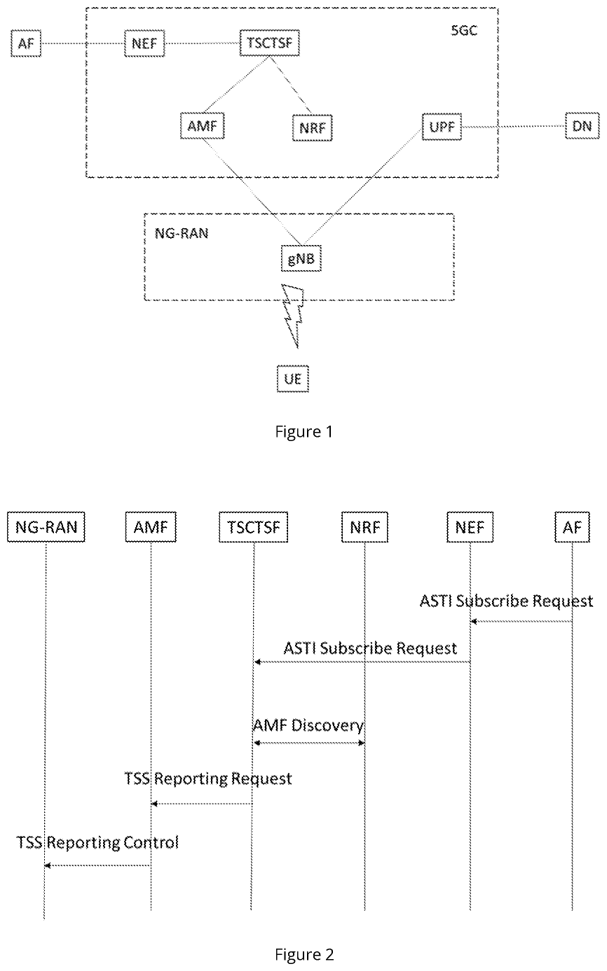

FIG. 1 shows a simple representation of one example of a 3GPP 5G system architecture. All the units shown in FIG. 1 are logical units. The connections shown in FIG. 1 are logical connections; the actual physical connections may be different. A 5G system may comprise other functions and structures than those shown in FIG. 1.

A core network may provide connections between devices implementing user equipment functionality (UEs) and one or more data networks (DN) via a New Generation Radio Access Network (NG-RAN) comprising a network of devices implementing instances of gNB (gNodeB) functionality.

A gNB is (i) connected to a user plane function (UPF) of the core network (CN), for routing and forwarding user data packets and for providing connectivity of devices to one or more external packet data networks (DN), and (ii) is connected to an access mobility management function (AMF) of the core network (CN) for controlling access and changes of serving cells for UEs.

The term “user equipment” (UE) may refer to any device, apparatus or component implementing at least 3GPP user equipment (UE) functionality.

The UE may be a mobile or static device (e.g. a portable or non-portable computing device) including, but not limited to, the following types of devices: mobile phone, smartphone, personal digital assistant (PDA), handset, device using a wireless modem (alarm or measurement device, etc.), laptop and/or touch screen computer, tablet, game console, notebook, and multimedia device. It should be appreciated that a UE device may also be a nearly exclusive uplink only device, of which an example is a camera or video camera loading images or video clips to a network. A UE device may also be a device having capability to operate in Internet of Things (IoT) network which is a scenario in which objects are provided with the ability to transfer data over a network without requiring human-to-human or human-to-computer interaction, e.g. to be used in smart power grids and connected vehicles. The device may also utilise cloud. In some applications, a UE device may comprise a user portable device with radio parts (such as a watch, earphones or eyeglasses) and the computation is carried out in the cloud.

5G enables using multiple input—multiple output (MIMO) antennas, and may involve large numbers of base stations (gNBs) including macro sites operating in co-operation with smaller stations and employing a variety of radio technologies depending on service needs, use cases and/or spectrum available. 5G mobile communications supports a wide range of use cases and related applications including video streaming, augmented reality, different ways of data sharing and various forms of machine type applications (such as (massive) machine-type communications (mMTC), including vehicular safety, different sensors and real-time control). 5G may employ multiple frequency bands, e.g. below 6GHz or above 24 GHz, cmWave and mmWave, and may also be integrable with existing legacy radio access technologies, such as LTE. Integration with LTE may be implemented, as a system, where macro coverage is provided by LTE and 5G radio interface access comes from small cells by aggregation to the LTE. In other words, 5G may support both inter-RAT operability (such as LTE-5G) and inter-RI operability (inter-radio interface operability, such as below 6GHz—cmWave, 6 or above 24 GHz—cmWave and mmWave). 5G networks may employ network slicing, in which multiple independent and dedicated virtual sub-networks (network instances) may be created within the same infrastructure to run services that have different requirements on latency, reliability, throughput and mobility.

Low latency applications and services may be facilitated by bringing content close to the 5G system, which leads to local break out and multi-access edge computing (MEC). 5G enables analytics and knowledge generation to occur at the source of the data. This approach may involve leveraging resources that may not be continuously connected to a network such as laptops, smartphones, tablets and sensors. MEC provides a distributed computing environment for application and service hosting. It also has the ability to store and process content in close proximity to cellular subscribers for faster response time. Edge computing covers a wide range of technologies such as wireless sensor networks, mobile data acquisition, mobile signature analysis, cooperative distributed peer-to-peer ad hoc networking and processing also classifiable as local cloud/fog computing and grid/mesh computing, dew computing, mobile edge computing, cloudlet, distributed data storage and retrieval, autonomic self-healing networks, remote cloud services, augmented and virtual reality, data caching, Internet of Things (massive connectivity and/or latency critical), critical communications (autonomous vehicles, traffic safety, real-time analytics, time-critical control, healthcare applications).

5G may also utilize satellite communication to enhance or complement the coverage of 5G service, for example by providing backhauling. Possible use cases are providing service continuity for machine-to-machine (M2M) or Internet of Things (IoT) devices or for passengers on board of vehicles, Mobile Broadband, (MBB) or ensuring service availability for critical communications, and future railway/maritime/aeronautical communications. Satellite communication may utilise geostationary earth orbit (GEO) satellite systems, but also low earth orbit (LEO) satellite systems, in particular mega-constellations (systems in which hundreds of (nano)satellites are deployed). Each satellite in the mega-constellation may cover several satellite-enabled network entities that create on-ground cells. The on-ground cells may be created through an on-ground relay node or by a gNB located on-ground or in a satellite.

The 5GC adopts a service-based architecture (SBA) according to which communication between network functions uses Service Based Interfaces (SBIs). Application Programming Interfaces (APIs) are used for the SBIs.

Example embodiments are described below for the example of the 3GPP ASTI (Access Stratum Time Information) service by which an Application Function (AF) can request time synchronization as a service for a UE or a group of UEs. A Time Sensitive Communication and Time Synchronization Function (TSCTSF) is a network function responsible for receiving AFs request for time synchronization and configuring the service within the 5GS.

Delivering 5G clock (e.g., UTC) information to a UE may, for example, involve a gNB providing 5G timing information to the UE via Uu interface, using e.g. system information block SIB9. The 5G timing information may be contained in a Reference Time Information (RTI) information element in the system information block SIB9.

FIG. 2 shows a representation of an example of operations according to some example embodiments.

An application function (AF) outside the 5G core network (5GC) sends a Nnef_ASTI SubscribeRequest message to a network exposure function (NEF) of the 5GC. The message includes identifiers of one or more target UEs and includes a Guarantee TSS RX flag set to “ON”, indicating that the network is to take action to guarantee that the target UEs receive TSS reports. The message may also indicate an urgency level.

In response to receiving the Nnef_ASTISubscribeRequest message, the NEF sends a Ntsctsf_ASTISubscribeRequest message to TSCTSF of the 5GC. The Ntsctsf_ASTISubscribeRequest message also identifies one or more target UEs and includes a Guarantee Timing Synchronization Status (TSS) reception (RX) flag set to “ON”, indicating that the network is to take action to guarantee that the target UEs receive TSS reports. If the Nnef_ASTI SubscribeRequest message from AF includes an urgency level indicator, the Ntsctsf_ASTISubscribeRequest to TSCTSF also includes an indicator of the urgency level.

TSCTSF makes one or more discovery requests to a network repository function (NRF) of the 5GC to discover the addresses of the one or more AMF instances currently associated with the target UEs identified in the Ntsctsf_ASTISubscribeRequest message.

TSCTSF sends one or more Namf_NonUeN2MsgTransfer messages to the one or more AMF instances discovered via NRF. The Namf_NonUeN2MsgTransfer message to each AMF instance indicates the target UEs and includes a Guarantee TSS RX flag set to “ON”, indicating that the network is to take action to guarantee that the target UEs receive TSS reports. If the Ntsctsf_ASTISubscribeRequest message includes an urgency level indicator, the Namf_NonUeN2MsgTransfer message also includes an indicator of the urgency level.

The AMF sends a Next Generation Application Protocol (NGAP): TSS Reporting Control message to one or more NG-RAN gNBs. The NGAP: TSS Reporting Control message to each AMF instance indicates the target UEs and includes a Guarantee TSS RX flag set to “ON”, indicating that the network is to take action to guarantee that the target UEs receive TSS reports. If the Namf_NonUeN2MsgTransfer message from TSCTSF includes an urgency level indicator, the NGAP: TSS Reporting Control message to gNB also includes an indicator of the urgency level.

In the above-described example, requests for RAN TSS reports by TSCTSF to AMF and the forwarding of those requests to gNB are done by node level signalling, but this may also be achieved by, for example, UE-associated signaling.

As one example of an alternative to the AF requesting (via exposure framework) the guaranteed reception of RAN TSS at one or more UEs is for the one or more UEs to make a direct request to gNB. The gNB would then forward an indication of this request to the TSCTSF (via AMF) to keep TSCTSF aware of the request. Such a direct request by UE may be done directly via RRC signaling. For example, a new information element (IE) may be included as part of RRC signaling, in addition to the information element UEAssistanceInformation IE by which a UE may indicate a preference for RTI provisioning.

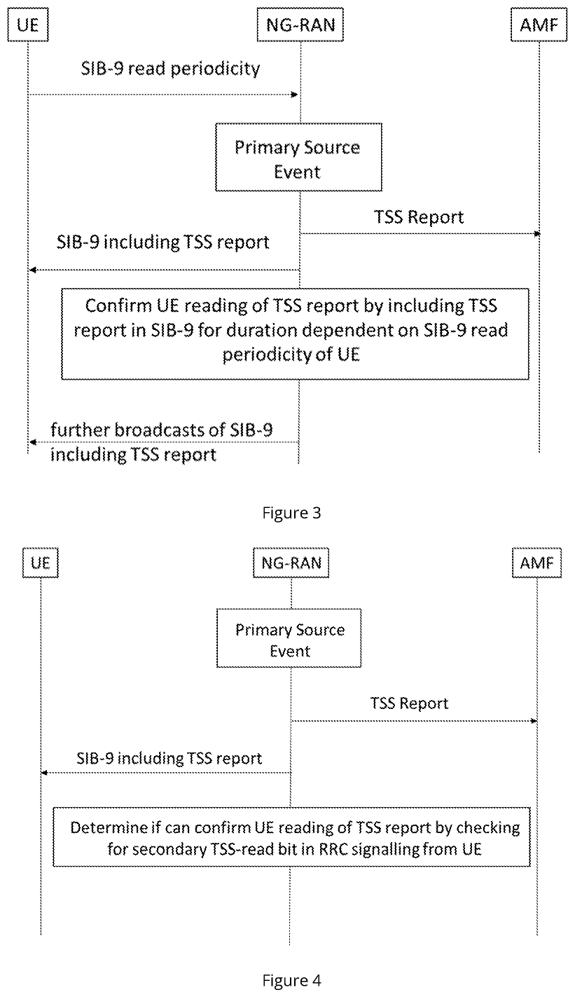

FIG. 3 shows a representation of further operations according to some example embodiments at a gNB that has received a NGAP: TSS Reporting Control message identifying one or more UEs having RRC INACTIVE status.

A primary source event (e.g., detection of network timing synchronization degradation/failure/improvement/recovery at gNB) triggers gNB to generate a TSS report, to include the TSS report in system information (e.g. system information block (SIB9)) broadcast by gNB, and to send the TSS report to the AMF instance associated with the gNB. The SIB9 broadcast by gNB includes a field including reference time information (RTI), and a field including the TSS report.

For each RRC INACTIVE UE identified in the NGAP: TSS Reporting Control message received from the AMF instance, gNB has information about the periodicity at which UE reads SIB. For example, gNB may have received this information directly from UE when UE had RRC CONNECTED status (as shown in FIG. 3) or may have received this information from AF via TCSTSF and AMF. gNB continues to include the TSS report in SIB9 broadcasts for a duration based on the information about the periodicity that UE reads SIB9, such that there is increased certainty that UE reads the TSS report. Including the TSS report in more than SIB9 broadcast serves to confirm that the UE reads the TSS report. For example, gNB continues to include the RAN TSS report in SIB9 broadcasts for a period of time that is longer than the UE's SIB9 reading periodicity.

FIG. 4 shows a representation of operations at gNB according to some other example embodiments.

A primary source event (e.g., detection of network timing synchronization degradation/failure/improvement/recovery at gNB) triggers gNB to generate a TSS report, to include the TSS report in system information (e.g. system information block (SIB9)) broadcast by the gNB, and to send the TSS report to the AMF instance associated with the gNB. The SIB9 broadcast by gNB includes a field including reference time information (RTI), and a field including the TSS report.

A UE having RRC INACTIVE status may have one or more internal triggers to re-establish the connection to the gNB (and switch to RRC_CONNECTED status) for a primary cause other than to report reading of a TSS report. The RRC signaling message that UE then sends may be adapted to have an additional (secondary purpose) field for indicating that the UE has read a TSS report. The information that gNB has about UE may include information derived from these RRC signaling messages from the UE and/or (in the case of RRC signalling having a time-based trigger) information about when UE is next expected to send such RRC signalling. If the information provided by these RRC signalling messages meets the urgency level specified in the NGAP: TSS Reporting Control message from AMF or (if no urgency level is specified in the NGAP: TSS Reporting Control message from AMF) a default urgency level stored at gNB, gNB refrains from paging UE to switch to RRC CONNECTED status for the primary purpose of reporting reading of the TSS report. On the other hand, if the information provided by these RRC signalling messages does not or cannot meet the urgency level specified in the NGAP: TSS Reporting Control message from AMF or (if no urgency level is specified in the NGAP: TSS Reporting Control message from AMF) a default urgency level stored at gNB, gNB proceeds to page UE to trigger UE to switch to RRC CONNECTED status for the primary purpose of acknowledging reading of the TSS report. In either event, gNB receives an explicit acknowledgment that UE has read the TSS report, thus increasing certainty at the gNB that UE has read the TSS report.

For example, gNB could start a timer upon broadcasting the TSS report (as part of SIB9). The timer may have a value determined by an urgency level indicated in the NGAP: TSS Reporting Control message from AMF, or a default value if there is no urgency level indicated in the NGAP: TSS Reporting Control message from AMF. If upon expiry of the timer, gNB has not received from UE any RRC signalling indicating reading of the TSS report, gNB may, for example, then determine to itself page the UE (under control of the gNB) to check if the UE has read the TSS report via SIB9. In the event of there being more than one such UE, gNB may control the paging of the multiple UEs to ensure that the random access by the multiple UEs is randomized. One example of an alternative action upon expiry of the timer is for gNB to notify the TSCTSF of one or more UEs for which gNB has not received RRC signaling indicating reading of the TSS report. TSCTSF would then control the paging of those UEs to the TSCTSF, thereby centralizing the management of the UEs at the TSCTSF.

Periodic control procedures that may be adapted for the additional, secondary purpose of providing gNB with information about reading of a TSS report may involve RRC signaling that is e.g., time triggered, mobility triggered, or event triggered. For example, a Mobility Registration Update message (RRC signalling having a mobility based trigger) may include an additional (e.g. 1-bit) field for UE to indicate reading of a TSS report; and TSCTSF could influence AMF to configure a smaller registration area for UE, with the aim of increasing the probability of gNB receiving an indication of TSS report reading via a Mobility Registration Update message in time to avoid paging UE to switch to RRC connected status for the primary purpose of reporting reading of a TSS report. As another example, a periodic Registration update message (controlled by periodic registration update timer 3512), or a RNA update message (controlled by timer T380) may include an additional (e.g. 1-bit) field for UE to indicate reading of a TSS report. gNB may have information about when UE is next expected to send these time-triggered RRC signaling messages, and gNB may determine whether such a message is expected from UE in time to avoid paging UE to switch to RRC CONNECTED status for the primary purpose of reporting reading of a TSS report.

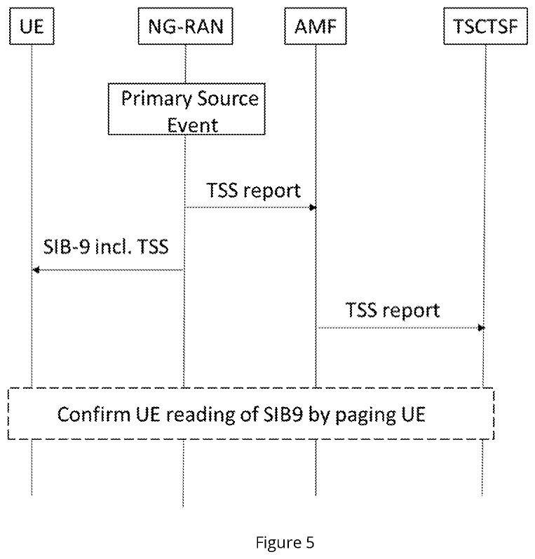

FIG. 5 shows a representation of example operations at gNB and TSCTSF according to some example embodiments.

A primary source event (e.g., detection of network timing synchronization degradation/failure/improvement/recovery at gNB) triggers gNB to generate a TSS report, to include the TSS report in system information (e.g. system information block (SIB9)) broadcast by the gNB, and to send the TSS report to the AMF instance associated with the gNB. The SIB9 broadcast by gNB includes a field including reference time information (RTI), and a field including the TSS report.

For each target UE (of those identified in the NGAP: TSS Reporting Control message received from the AMF instance) for which information at gNB indicates that the UE does not have RRC INACTIVE status (or RRC CONNECTED status), gNB does not take any action to increase certainty that the UE has read the TSS report. In response to receiving the TSS report from gNB via AMF, TSCTSF determines which target UEs (of those identified in the Ntsctsf_SubscribeRequest message from AF via NEF) have RRC IDLE status and have some recent association with the gNB from which the TSS report is received. For this subset of target UEs, TSCTSF initiates paging of messages indicating the broadcast by gNB of a TSS report. This action increases the certainty that RRC IDLE status UEs camped on a cell operated by gNB will read the TSS report broadcast by gNB.

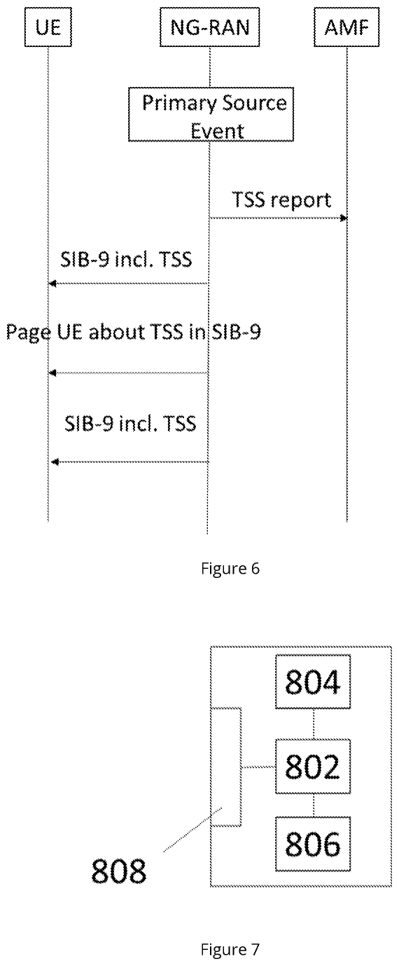

FIG. 6 shows a representation of an example of operations at gNB according to some example embodiments.

A primary source event (e.g., detection of network timing synchronization degradation/failure/improvement/recovery at gNB) triggers gNB to generate a TSS report, to include the TSS report in system information (e.g. system information block (SIB9)) broadcast by the gNB, and to send the TSS report to the AMF instance associated with the gNB. The SIB9 broadcast by gNB includes a field indicating a reference time information (RTI), and a field including the TSS report.

For each target UE (of those identified in the NGAP: TSS Reporting Control message received from the AMF instance), for which gNB has information indicating that the UE is camped with RRC INACTIVE status on a cell operated by gNB, gNB pages the UE to inform the UE of an upcoming broadcast of SIB9 including a TSS report. UE thus becomes aware that the next broadcast of SIB9 includes a TSS report and reads the next broadcast of SIB9. This action by gNB increases the certainty that the target UEs read the TSS.

The above-described example involving gNB using information about the SIB9 read periodicity of the UEs, and the above-described example involving the gNB sending a page message indicating that an upcoming SIB9 broadcast will include a RAN TSS report, are examples of implicit confirmation techniques. Implicit confirmation techniques can better avoid the RAN congestion that can arise from the reconnection of a large number of UEs in response to the same event.

Some features of some example embodiments are as follows:

The AF may request guaranteed/acknowledged reception of 5G network timing synchronization status report for a UE or a group of UE(s). For example, an additional flag is added to the exposure APIs between AF and TSCTSF. The AF may indicate how urgent the acknowledgement needs to be done to influence how to react in the event the UE is not receiving the 5G RAN timing synchronization status report from the RAN.

The 5GS (either the gNB or the TSCTSF) ensures that the UE reads the 5G RAN timing synchronization status report. Multiple options include:
(a) The RAN timing synchronization status report within the SIB is reported for a long period (or always) within the cell. It is up to the gNB to determine for how long (or if always) the RAN timing synchronization status report should be provided. To assist in the decision, the UE may indicate to the gNB the periodicity which the UE will read SIB9 before the UE releases or suspends the RRC connection. This indication from the UE can have two uses at the gNB: i) to enable the gNB to determine the minimum period it should repeat the RAN timing synchronization status report to make sure the UE will read the timing synchronization status report, and ii) to let the gNB know that the UE requires this guaranteed reception of the report (i.e., as an alternative to the AF requesting guaranteed reception of 5G network timing synchronization status report).
(b) The gNB or the TSCTSF may rely on the periodic control procedures the UE is performing with the network based on event triggers (e.g., time based, mobility based, or other event based) to expect for a confirmation from the UE of the reception of the RAN timing synchronization status report. For this confirmation, the UE may add a bit into the signaling message that the UE sends to the network.
(c) The gNB may page the UEs to indicate that the upcoming SIB9 will include a RAN timing synchronization status report. The UEs do not need to reconnect with the network if they are in RRC_IDLE/INACTIVE, the UEs read the subsequent SIB9 after the paging.
(d) The gNB or the TSCTSF may rely on paging the UEs. The paging message can include again the RAN timing synchronization status report broadcasted in the cell and when the UE reconnects to the network due to the paging, it could add a bit to confirm the reception of the report. This may avoid multiple UEs trying to reconnect in a short period of time (i.e., allows the gNB or TSCTSF to control access to the network to uncorrelated the reconnection to the new report event).

If guaranteed/acknowledged reception of 5G RAN timing synchronization status report for a UE is required, the AF may include a flag to indicate the need for guaranteed/acknowledged reception and may also include a value of how urgent the acknowledgement is required.

If guaranteed/acknowledged reception of 5G RAN timing synchronization status report for a UE is required, the UE is in RRC_INACTIVE/IDLE, and the gNB decided to use SIB9 for broadcasting the report in the cell, the gNB may repeat the report within SIB9 for a long period of time in the cell to ensure the UE will read the report. To determine for how long the gNB should repeat the report, the gNB may use additional information provided by the AF and forwarded via TSCTSF/AMF (i.e. the target UEs that require this guaranteed mode) or by the UE (e.g. UE indicates how often it will read SIB9 before changing to RRC_INACTIVE/IDLE). It is up to the gNB or TSCTSF to determine how the guaranteed/acknowledged reception of RAN timing synchronization status report for a UE is achieved (e.g. relying on upcoming control procedures the UE may perform with the gNB due to time/mobility/event-based triggers; or using the paging message to indicate to the UE that the upcoming SIB9 will include RAN timing synchronization status report for the UE to read it; or RAN/CN-initiated paging, etc).

If guaranteed/acknowledged reception of 5G RAN timing synchronization status report for a UE is required and the gNB decides to send the report via SIB9 to the UEs, the gNB may use different methods to allow the UE to read the RAN timing synchronization status report.

If guaranteed/acknowledged reception of 5G RAN timing synchronization status report for a UE is supported, the UE may indicate how often it will read SIB9 to the gNB.

FIG. 7 illustrates an example of an apparatus for implementing UE or RAN access node functionality in the architecture of FIG. 1. The apparatus may include at least one processor 802 coupled to one or more interfaces 808. For a UE, the one or more interfaces 808 may include one or more interfaces to e.g., other equipment/component(s) for which the UE functionality provides radio communications. For a RAN access node, the one or more interfaces 808 may include one or more interfaces to e.g., core network nodes implementing core network functions such as AMF, UPF etc.). The at least one processor 802 is also coupled to a radio unit 804 including one or more antennas etc. for making and receiving radio transmissions. The at least one processor 802 may also be coupled to at least one memory 806. The at least one processor 802 may be configured to execute an appropriate software code to perform the operations described above. The software code may be stored in the memory 806.

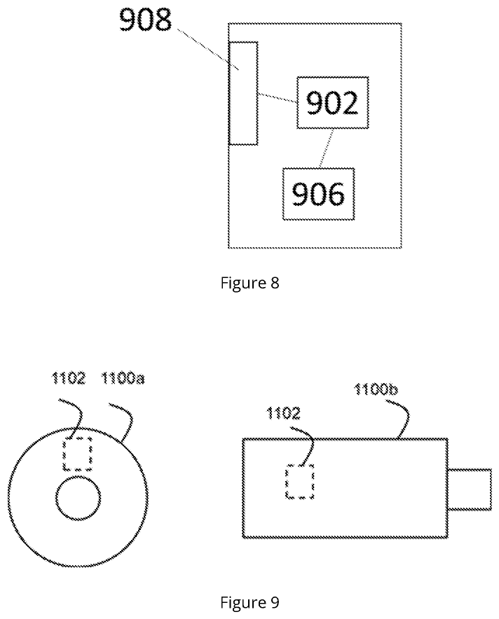

FIG. 8 illustrates an example of an apparatus for implementing any of the core network functions in FIG. 1. The apparatus may include at least one processor 902 coupled to one or more interfaces 908 for communication with other core network functions or NG-RAN (New Generation Radio Access Network) nodes. The at least one processor 902 may also be coupled to at least one memory 906. The at least one processor 902 may be configured to execute an appropriate software code to perform the operations described above. The software code may be stored in the memory 906.

FIG. 9 shows a schematic representation of non-volatile memory media 1100a (e.g., computer disc (CD) or digital versatile disc (DVD)) and 1100b (e.g., universal serial bus (USB) memory stick) storing instructions and/or parameters 1102 which when executed by a processor allows the processor to perform one or more of the steps of the methods described previously.

It is to be noted that example embodiments may be implemented as circuitry, in software, hardware, application logic or a combination of software, hardware and application logic. In an example embodiment, the application logic, software or an instruction set is maintained on any computer-readable media. In the context of this document, a “computer-readable medium” may be any media or means that can contain, store, communicate, propagate or transport the instructions for use by or in connection with an instruction execution system, apparatus, or device, such as the base stations or user equipment of the above-described example embodiments.

As used in this application, the term “circuitry” refers to all of the following: (a) hardware-only circuit implementations (such as implementations in only analog and/or digital circuitry) and (b) to combinations of circuits and software (and/or firmware), such as (as applicable): (i) to a combination of processor(s) or (ii) to portions of processor(s)/software (including digital signal processor(s)), software, and memory(ies) that work together to cause an apparatus, such as the user equipment or base stations of the above-described embodiments, to perform various functions) and (c) to circuits, such as a microprocessor(s) or a portion of a microprocessor(s), that require software or firmware for operation, even if the software or firmware is not physically present. This definition of ‘circuitry’ applies to all uses of this term “means” in this application, including in any claims. As a further example, as used in this application, the term “circuitry” would also cover an implementation of merely a processor (or multiple processors) or portion of a processor and its (or their) accompanying software and/or firmware. The term “circuitry” would also cover, for example and if applicable to the particular claim element, a baseband integrated circuit or applications processor integrated circuit for a mobile phone or a similar integrated circuit in server, a cellular network device, or other network device.

The features, advantages, and characteristics described herein can be combined in any suitable manner in one or more example embodiments. One skilled in the relevant art will recognize that such example embodiments can be practiced without one or more of the specific features or advantages of a particular embodiment. In other instances, additional features and advantages can be recognized in certain embodiments that may not be present in all example embodiments. One having ordinary skill in the art will readily understand that the example embodiments as discussed above may be practiced with steps in a different order, and/or with hardware elements in configurations which are different than those which are disclosed. Therefore, although some embodiments have been described based upon these example embodiments, it would be apparent to those of skill in the art that certain modifications, variations, and alternative constructions would be apparent, while remaining within the spirit and scope of example embodiments.

1. A method, comprising:
receiving a message identifying at least one user equipment for which action is to be taken to increase certainty of reading by the user equipment of a timing synchronisation status report; and
based at least partly on information about the user equipment, determining an action for increasing certainty of reading by the user equipment of the timing synchronisation status report.

2. The method according to claim 1, wherein the message includes an indication of a level of urgency for increasing certainty of reading by the user equipment of the timing synchronisation status report; and wherein the determining an action is based partly on the indication of the level of urgency.

3. The method according to claim 1, wherein the timing synchronisation status report is broadcast as part of system information, wherein the information about the user equipment comprises information about periodicity at which the user equipment reads broadcast system information; and wherein the method comprises determining at least one parameter for the broadcast of the timing synchronisation status report as part of system information, based on the information about periodicity at the user equipment of reading broadcast system information.

4. The method according to claim 3, wherein the at least one parameter comprises a duration for which the timing synchronisation status report is included in system information.

5. The method according to claim 1, comprising: determining whether to page the user equipment to report reading of the timing synchronisation status report, wherein the determining is at least partly based on one or more of: information derived from user equipment messages, or information about when to expect user equipment messages.

6. The method according to claim 5, wherein determining whether to page the user equipment to report reading of the timing synchronisation status report is at least partly based on one or more of: information derived from one or more messages from the user equipment including a field for indicating reading of the timing synchronisation status report, or information about when the user equipment is next expected to send a message including a field for indicating reading of the timing synchronisation status report.

7. The method according to claim 1, wherein the information about the user equipment includes the radio resource control status of the user equipment, and wherein the method comprises: in response to determining that the user equipment is in radio resource control idle mode, paging the user equipment about broadcast of the timing synchronisation status report.

8-13. (canceled)

14. An apparatus, comprising:
at least one processor; and
at least one memory storing instructions which, when executed by the at least one processor, cause the apparatus to perform operations, the operations comprising:
receiving a message identifying at least one user equipment for which action is to be taken to increase certainty of reading by the user equipment of a timing synchronisation status report; and
based at least partly on information about the user equipment, determining an action for increasing certainty of reading by the user equipment of the timing synchronisation status report.

15. The apparatus according to claim 14, wherein the message includes an indication of a level of urgency for increasing certainty of reading by the user equipment of the timing synchronisation status report; and wherein the determining an action is based partly on the indication of the level of urgency.

16. The apparatus according to claim 14, wherein the timing synchronisation status report is broadcast as part of system information, wherein the information about the user equipment comprises information about periodicity at which the user equipment reads broadcast system information; and wherein the operations further comprise determining at least one parameter for the broadcast of the timing synchronisation status report as part of system information, based on the information about periodicity at the user equipment of reading broadcast system information.

17. The apparatus according to claim 16, wherein the at least one parameter comprises a duration for which the timing synchronisation status report is included in system information.

18. The apparatus according to claim 14, wherein the operations further comprise determining whether to page the user equipment to report reading of the timing synchronisation status report, wherein the determining is at least partly based on one or more of: information derived from user equipment messages, or information about when to expect user equipment messages.

19. The apparatus according to claim 18, wherein determining whether to page the user equipment to report reading of the timing synchronisation status report is at least partly based on one or more of: information derived from one or more messages from the user equipment including a field for indicating reading of the timing synchronisation status report, or information about when the user equipment is next expected to send a message including a field for indicating reading of the timing synchronisation status report.

20. The apparatus according to claim 14, wherein the information about the user equipment includes the radio resource control status of the user equipment, and wherein the operations further comprise in response to determining that the user equipment is in radio resource control idle mode, paging the user equipment about broadcast of the timing synchronisation status report.

21. Apparatus, comprising:
at least one processor; and
at least one memory storing instructions which, when executed by the at least one processor, cause the apparatus to perform operations, the operations comprising:
receiving a message identifying at least one user equipment for which action is to be taken to increase certainty of reading by the user equipment of a timing synchronisation status report;
paging the user equipment about broadcast of a timing synchronisation status report; and
broadcasting the timing synchronisation report.

22-37. (canceled)
